(19) United States
(12) Patent Application Publication
(10) Pub. No.: US 2010/0214774 A1
(43) Pub. Date: Aug. 26, 2010

(54) LIGHT EMITTING DEVICE WITH A SOLAR BULB

(76) Inventors: Tzu-Wei Liu, Taichung City (TW); Chian-Chi Huang, Taipei City (TW); Min-Feng Huang, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/394,014

(22) Filed: Feb. 26, 2009

(51) Int. Cl. F21L 4/00

(52) U.S. Cl. 362/183

(57) ABSTRACT

A light emitting device is disclosed. The light emitting device includes a bottle, and a solar bulb for capping with the bottle. The solar bulb includes a housing, a solar panel disposed on the housing for converting solar energy into electric energy, a rechargeable battery module installed inside the housing for storing the electric energy generated by the solar panel, a light source installed inside the housing for emitting light to the bottle, and a control circuit installed inside the housing and coupled to the solar panel and the rechargeable battery module for transmitting the electric energy from the rechargeable battery module to the light source.

### BACKGROUND OF THE INVENTION

1. Field of the Invention

The present invention relates to a light emitting device with a solar bulb, and more particularly, to a light emitting device with a solar bulb capable of converting solar energy into electric energy for lightening.

2. Description of the Prior Art

In general, a chemical battery can transfer chemical energy into electric energy. The chemical battery includes advantages of portability, high energy density, no noise, and so on, so the chemical battery is widely used in a notebook computer, and portable electronic apparatus, such as mobile phones and digital cameras. There are two kinds of the chemical battery, a non-rechargeable battery and a rechargeable battery. The non-rechargeable battery only can be used once, and chemical energy can not be supplied by charging the battery. The non-rechargeable batteries are a dry battery, a mercury battery, an alkaline battery, and so on. The rechargeable battery can be used repeatedly, and chemical energy can be supplied by charging the battery. The rechargeable batteries are a lead-acid battery, a NiMH battery, a lithium battery, an advanced lithium battery, and so on. However, when the non-rechargeable battery and the rechargeable battery run out of electricity, the non-rechargeable battery and the rechargeable battery can not provide electricity anymore at the moment, causing inconvenient to operate electronic apparatuses. In addition, the chemical battery has disadvantages of difficulty of recycling, pollution, and low charging speed.

With improvement of battery technology and due to increasing awareness of environmental protection issues, many charging devices for recharging electronic products with clean energy are manufactured accordingly, such as a solar charger, a hand-powered device, and so forth. The solar charger involves utilizing a solar panel to absorb solar energy so as to convert the solar energy into electric energy. The hand-powered device involves utilizing a motor that may convert mechanical energy into electric energy, meaning that a user may rotate a drive shaft of the motor to make electromagnetic induction occur in the motor to generate the electric energy. However, for a hand-powered device, a user needs to provide mechanical energy so that the motor may be driven to generate electric energy, such as shaking the hand-powered device or rotating the drive shaft of the hand-powered device. Thus, it is time and energy consuming to use the hand-powered device to charge electronic products. Besides, charging efficiency of a hand-powered device is not as good as that of a solar charger. Hence, there is a need to apply solar conversion modules for environmental design of electronic products.

### SUMMARY OF THE INVENTION

An exemplary embodiment of a light emitting device is disclosed. The light emitting device includes a bottle, and a solar bulb for capping with the bottle. The solar bulb includes a housing, a solar panel disposed on the housing for converting solar energy into electric energy, a rechargeable battery module installed inside the housing for storing the electric energy generated by the solar panel, a light source installed inside the housing for emitting light to the bottle, and a control circuit installed inside the housing and coupled to the solar panel and the rechargeable battery module for transmitting the electric energy from the rechargeable battery module to the light source.

Another exemplary embodiment of a solar bulb for capping with a bottle is disclosed. The solar bulb includes a housing, a solar panel disposed on the housing for converting solar energy into electric energy, a rechargeable battery module installed inside the housing for storing the electric energy generated by the solar panel, a light source installed inside the housing for emitting light to the bottle, and a control circuit installed inside the housing and coupled to the solar panel and the rechargeable battery module for transmitting the electric energy from the rechargeable battery module to the light source.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a perspective drawing of a light emitting device according to a preferred embodiment of the present invention.

FIG. 2 to FIG. 4 are perspective drawings at different views of a solar bulb according to the preferred embodiment of the present invention.

FIG. 5 is a diagram illustrating inner components of the solar bulb according to the preferred embodiment of the present invention.

FIG. 6 to FIG. 8 are diagrams illustrating a casing rotating relative to a base in different degrees of freedom according to the preferred embodiment of the present invention.

### DETAILED DESCRIPTION

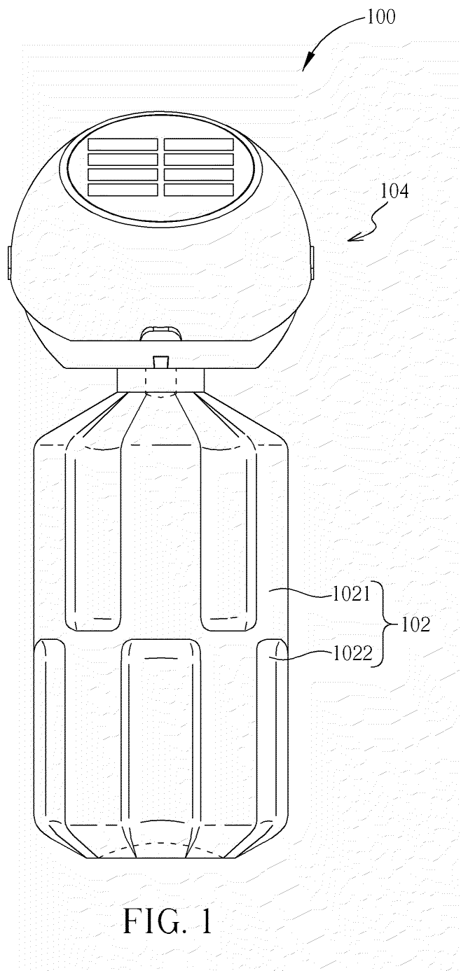

Please refer to FIG. 1. FIG. 1 is a perspective drawing of a light emitting device 100 according to a preferred embodiment of the present invention. The light emitting device 100 includes a bottle 102, and a solar bulb 104 capped with the bottle 102. The solar bulb 104 can be screwed on the bottle 102 as a bottle cap. Fluid, such as water, can be contained inside the bottle 102. The bottle 102 includes alternate a plurality of protruding parts 1021 and a plurality of sunken parts 1022. The disposition and the amount of the plurality of protruding parts 1021 and the plurality of sunken parts 1022 are not limited to this embodiment and can be designed upon actual demand. The bottle 102 also can include a smooth surface instead.

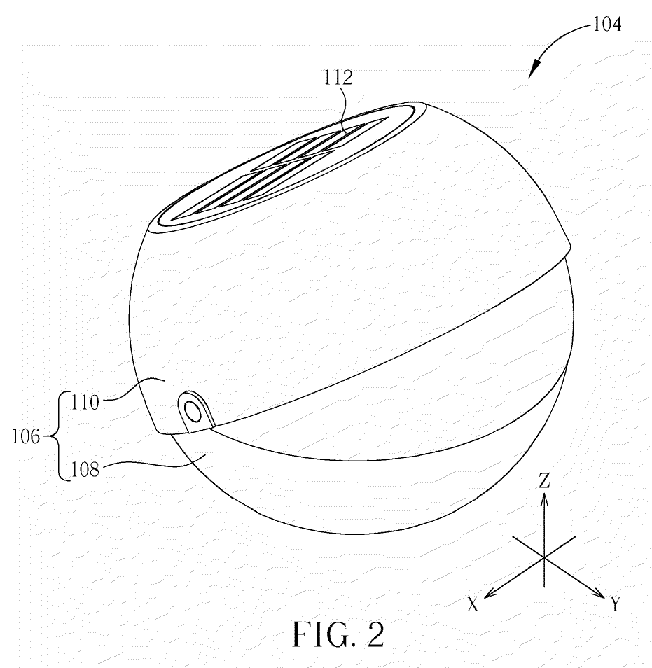

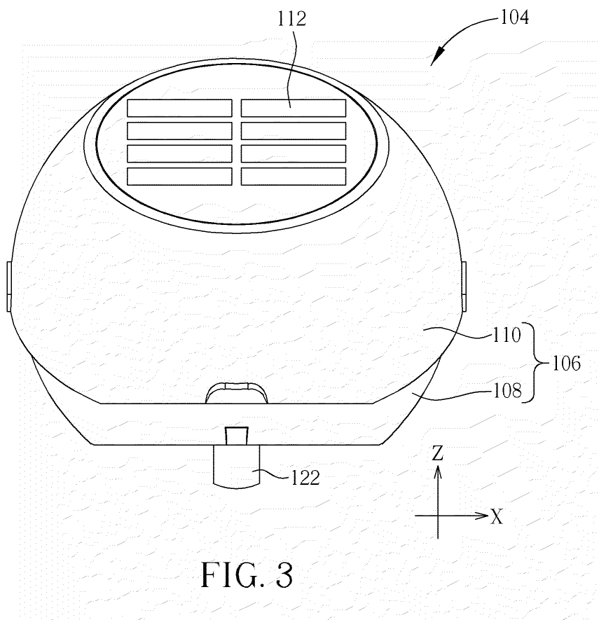

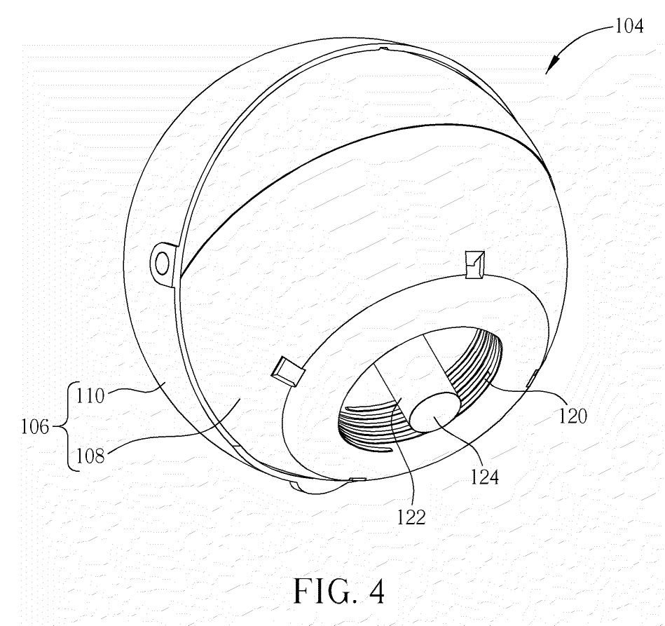

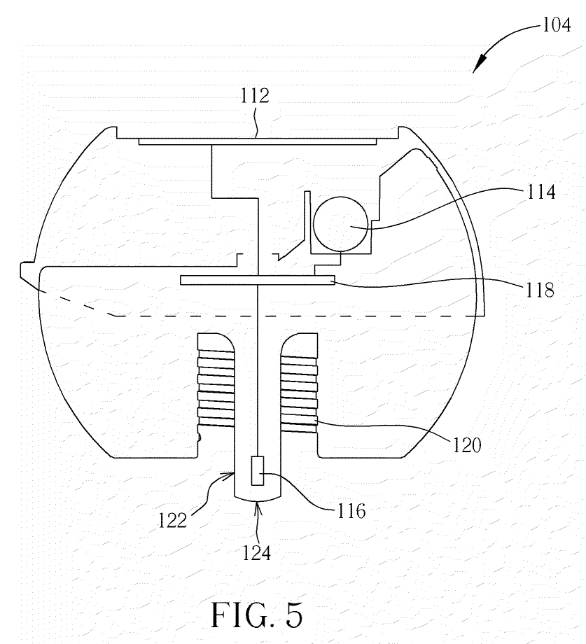

Please refer to FIG. 2 to FIG. 5. FIG. 2 to FIG. 4 are perspective drawings at different views of the solar bulb 104 according to the preferred embodiment of the present invention. FIG. 5 is a diagram illustrating inner components of the solar bulb 104 according to the preferred embodiment of the present invention. The solar bulb 104 includes a housing 106. The housing 106 includes a base 108 and a casing 110 connected to the base 108 in a rotatable manner. The casing 110 and the base 108 can be hemispheric structures substantially. The solar bulb 104 further includes a solar panel 112 disposed on the casing 110 of the housing 106 for converting solar energy into electric energy. The solar bulb 104 further includes a rechargeable battery module 114 installed inside the housing 106 for storing the electric energy generated by the solar panel 112.

The solar bulb 104 further includes a light source 116 installed inside the housing 106 for emitting light to the bottle 102. The light source 116 can be a light emitting diode (LED), a laser diode, a lamp, and combination thereof. The solar bulb 104 further includes a control circuit 118 installed inside the housing 106 and coupled to the solar panel 112 and the rechargeable battery module 114 for transmitting the electric energy from the rechargeable battery module 114 to the light source 116. The control circuit 118 can be formed on a circuit board, such as a printed circuit board. A thread 120 is formed on an inner surface of the housing 106 of the solar bulb 104 for screwing the bottle 102 so that the solar bulb 104 is a bottle cap for capping the bottle 102. The base 108 of the housing 106 includes a lance structure 122 for inserting into a mouth of the bottle 102, and the light source 116 is disposed inside the lance structure 122 so that the light source 116 is inserted into the bottle 102 when the bottle 102 is capped with the solar bulb 104. A light magnifying unit 124 is disposed on an end of the lance structure 122 and on an optical path of the light emitting to the bottle 102 from the light source 116. The light magnifying unit 124 is utilized for magnifying the light emitted from the light source 116. The light magnifying unit 124 can be a lens structure formed on the end of the solar bulb 104. Please refer to FIG. 1 and FIG. 5, the plurality of protruding parts 1021 and the plurality of sunken parts 1022 of the bottle 102 and the fluid contained inside the bottle 102 can refract the light emitted from the light source 116 to cause to glitter.

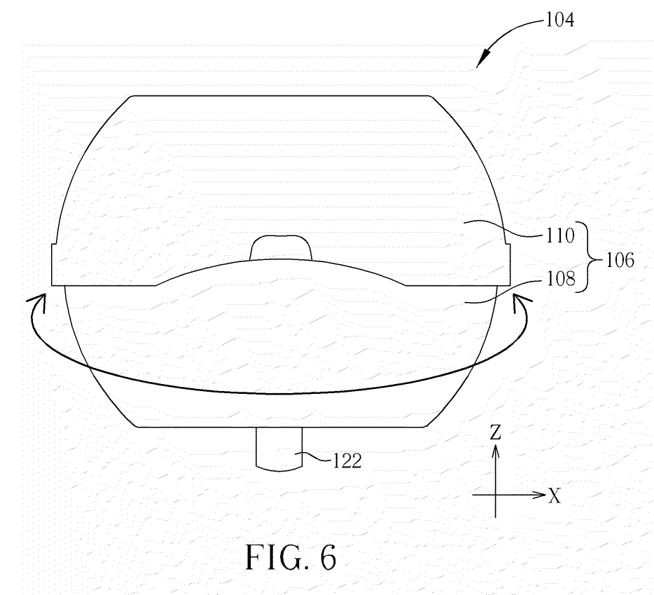

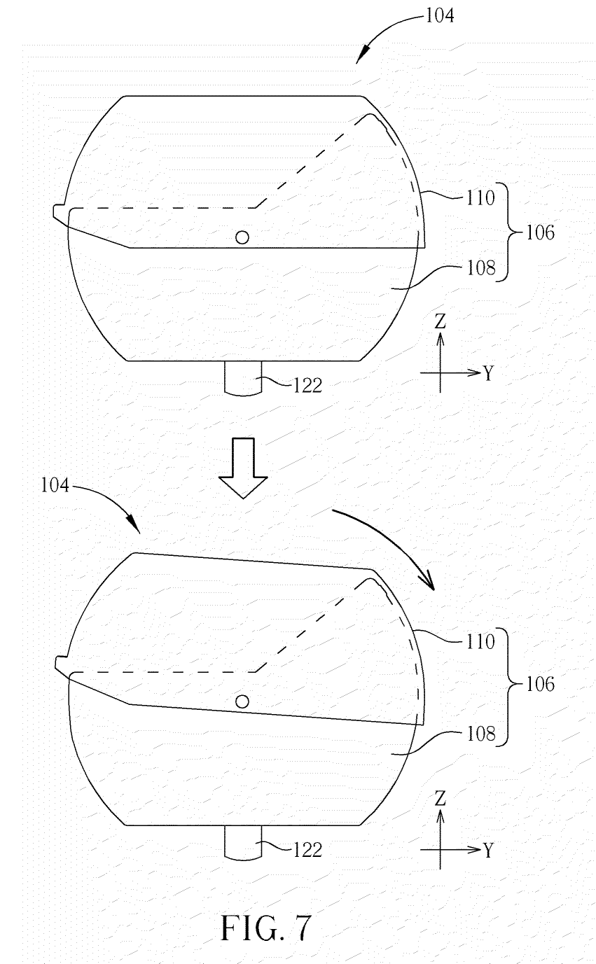

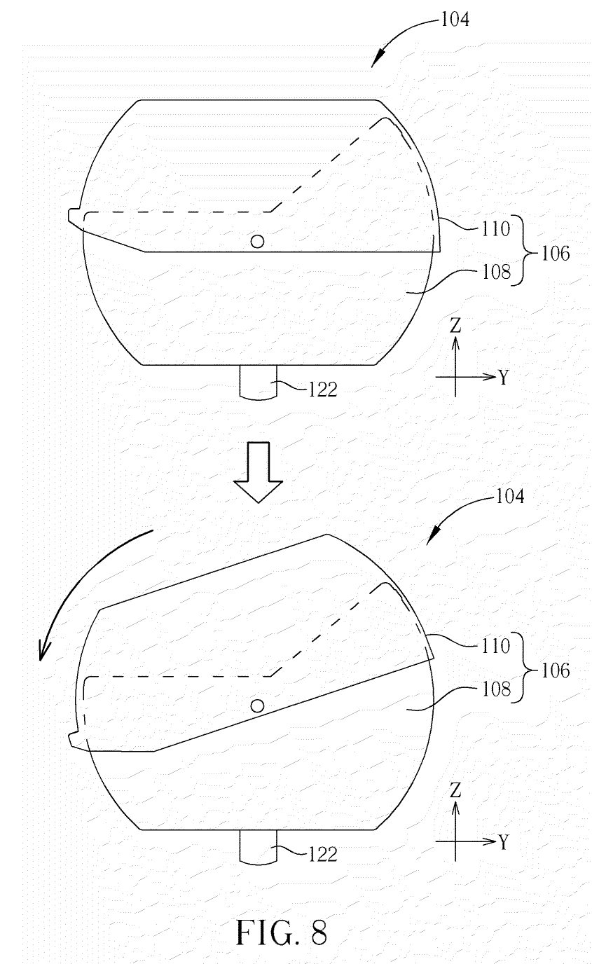

Please refer to FIG. 6 to FIG. 8. FIG. 6 to FIG. 8 are diagrams illustrating the casing 110 rotating relative to the base 108 in different degrees of freedom according to the preferred embodiment of the present invention. As shown in FIG. 6, the casing 110 is connected to the base 108 in a rotatable manner around the Z-axis direction. That is, the casing 110 is swivelable relative to the base 108 at 360 degrees. As shown in FIG. 7 and FIG. 8, the casing 110 is connected to the base 108 in a rotatable manner on the Y-Z plane clockwise and counterclockwise (around the X-axis direction) respectively. That is, the casing 110 is swingable relative to the base 108. Because the casing 110 has multiple rotational degrees of freedom, the solar panel 112 disposed on the casing 110 can be rotated to orient the sun so as to increase solar energy conversion efficiency. The rotary mechanism of the casing 100 is not limited to this embodiment and can be designed upon actual demand.

In contrast to the prior art, the light emitting device of the present invention includes the solar bulb capable of converting solar energy into electric energy for lightening. The present invention provides an environmental design of illumination devices.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A light emitting device comprising:
a bottle; and
a solar bulb for capping with the bottle, the solar bulb comprising:
a housing;
a solar panel disposed on the housing for converting solar energy into electric energy;
a rechargeable battery module installed inside the housing for storing the electric energy generated by the solar panel;
a light source installed inside the housing for emitting light to the bottle; and
a control circuit installed inside the housing and coupled to the solar panel and the rechargeable battery module for transmitting the electric energy from the rechargeable battery module to the light source.

2. The light emitting device of claim 1 further comprising fluid contained inside the bottle for refracting the light emitted from the light source.

3. The light emitting device of claim 2 wherein the fluid is water.

4. The light emitting device of claim 1 wherein the bottle comprises alternate a plurality of protruding parts and a plurality of sunken parts.

5. The light emitting device of claim 1 wherein a thread is formed on an inner surface of the housing of the solar bulb for screwing the bottle.

6. The light emitting device of claim 1 wherein the solar bulb further comprises a light magnifying unit for magnifying the light emitted from the light source.

7. The light emitting device of claim 1 wherein the housing comprises a lance structure for inserting into a mouth of the bottle.

8. The light emitting device of claim 7 wherein the light source is disposed inside the lance structure.

9. The light emitting device of claim 7 wherein the solar bulb further comprises a light magnifying unit disposed on an end of the lance structure for magnifying the light emitted from the light source.

10. The light emitting device of claim 1 wherein the housing comprises:
a base; and
a casing connected to the base in a rotatable manner.

11. The light emitting device of claim 10 wherein the casing is swivelable relative to the base.

12. The light emitting device of claim 10 wherein the casing is swingable relative to the base.

13. The light emitting device of claim 10 wherein the casing and the base are hemispheric structures substantially.

14. The light emitting device of claim 10 wherein the base comprises a lance structure for inserting into a mouth of the bottle and the light source is disposed inside the lance structure.

15. The light emitting device of claim 10 wherein the solar panel is disposed on the casing.

16. The light emitting device of claim 1 wherein the light source is selected from a group consisting of a light emitting diode (LED), a laser diode, a lamp, and combination thereof.

17. A solar bulb for capping with a bottle, the solar bulb comprising:
a housing;
a solar panel disposed on the housing for converting solar energy into electric energy;
a rechargeable battery module installed inside the housing for storing the electric energy generated by the solar panel;
a light source installed inside the housing for emitting light to the bottle; and
a control circuit installed inside the housing and coupled to the solar panel and the rechargeable battery module for transmitting the electric energy from the rechargeable battery module to the light source.

18. The solar bulb of claim 17 wherein a thread is formed on an inner surface of the housing of the solar bulb for screwing the bottle.

19. The solar bulb of claim 17 wherein the solar bulb further comprises a light magnifying unit for magnifying the light emitted from the light source.

20. The solar bulb of claim 17 wherein the housing comprises a lance structure for inserting into a mouth of the bottle.

21. The solar bulb of claim 20 wherein the light source is disposed inside the lance structure.

22. The solar bulb of claim 20 wherein the solar bulb further comprises a light magnifying unit disposed on an end of the lance structure for magnifying the light emitted from the light source.

23. The solar bulb of claim 17 wherein the housing comprises:
a base; and
a casing connected to the base in a rotatable manner.

24. The solar bulb of claim 23 wherein the casing is swivelable relative to the base.

25. The solar bulb of claim 23 wherein the casing is swingable relative to the base.

26. The solar bulb of claim 23 wherein the casing and the base are hemispheric structures substantially.

27. The solar bulb of claim 23 wherein the base comprises a lance structure for inserting into a mouth of the bottle and the light source is disposed inside the lance structure.

28. The solar bulb of claim 23 wherein the solar panel is disposed on the casing.

29. The solar bulb of claim 17 wherein the light source is selected from a group consisting of a light emitting diode (LED), a laser diode, a lamp, and combination thereof.
